(19) United States
(12) Patent Application Publication
(10) Pub. No.: US 2020/0010185 A1
(43) Pub. Date: Jan. 9, 2020

(54) AIRCRAFT

(71) Applicant: Dr. Ing. h.c. F. Porsche Aktiengesellschaft, Stuttgart (DE)

(72) Inventor: Stefan Bender, Löchgau (DE)

(73) Assignee: Dr. Ing. h.c. F. Porsche Aktiengesellschaft, Stuttgart (DE)

(21) Appl. No.: 16/460,465

(22) Filed: Jul. 2, 2019

(30) Foreign Application Priority Data
Jul. 4, 2018 (DE) 102018116152.2

(51) Int. Cl. B64C 29/00; B64C 27/82; B64C 27/24; B64C 27/26

(52) U.S. Cl. CPC B64C 29/0025; B64C 27/82; B64C 2201/141; B64C 27/26; B64C 27/24

(57) ABSTRACT

An aircraft has an emergency rotor, and the emergency rotor can be deployed from a rest position into a use position.

### CROSS-REFERENCE TO RELATED APPLICATION

This application claims priority to German Patent Application No. 10 2018 116 152.2, filed Jul. 4, 2018, the content of such application being incorporated by reference herein in its entirety.

### FIELD OF THE INVENTION

The present invention relates to an aircraft, in particular a fully electric VTOL (vertical take-off and landing) aircraft.

### BACKGROUND OF THE INVENTION

In aerospace engineering, VTOL covers any type of airplane, drone or rocket which is capable of taking off, and landing again, essentially vertically and without any take-off and landing runways. This umbrella term will be used hereinbelow in a broad sense to include not just fixed-wing aircraft, but also rotary-wing aircraft, such as helicopters, gyrocopters and gyrodynes, and hybrids, such as compound helicopters, as well as convertiplanes. Also covered are aircraft capable of taking off and landing on particularly short runways (short take-off and landing, STOL), of taking off on short runways, but of landing vertically (short take-off and vertical landing, STOVL), or of taking off vertically, but landing horizontally (vertical take-off and horizontal landing, VTHL).

U.S. Pat. No. 7,677,491B2, which is incorporated by reference herein, discloses an airborne delivery system having a deployable autorotating rotor system. The rotor system makes it easier to control the descent.

A deployable rotor according to U.S. Pat. No. 3,333,643A, which is incorporated by reference herein, has flexible blades and a collapsible structure for stowing in an extremely small amount of space, wherein the arrangement, once released, automatically deploys into an initial, partially open position, in which installed wings drive the rotor on account of the airstream during free fall and the rotor blades are disengaged in a step-wise manner by a mechanism which is dependent on the rotational speed, in which case deceleration increases gradually. Once the rotor is fully deployed, its direction can be controlled and it automatically regulates the speed of descent.

A deployable rotor according to U.S. Pat. No. 4,017,043A, which is incorporated by reference herein, can be used, for example, as a lifting device for an ejector seat, wherein the pitch of the rotor blades is varied in accordance with the rotational speed.

### SUMMARY OF THE INVENTION

An advantage of the aircraft described herein resides in the increased safety of a correspondingly equipped aircraft. During regular cruising operation, the rotor here is accommodated in a protected state in the aircraft and bird strikes are therefore not possible.

It is thus possible for the aircraft to be equipped, for example, with wings which are, or can even optionally be, angled. A corresponding variant increases the wing surface area which is effective during horizontal flight, without the aircraft footprint being extended.

Furthermore, the aircraft can have a rapid-charge battery system which provides the propulsion energy for vertical take-off and landing as well as horizontal flight and provides for quick charging of the aircraft when the latter is stationary.

For the drive of the aircraft, it is possible here, instead of free-moving rotors, to use a plurality of ducted fans, even ones of different sizes, as are known outside aerospace engineering, for example in relation to hovercraft or airboats. In such an embodiment, the cylindrical housing which encloses the propeller can significantly reduce the thrust-related losses as a result of turbulence at the blade tips. Suitable ducted fans can be oriented horizontally or vertically, can be pivoted between two positions or, for aerodynamic reasons, can be covered by louvers during horizontal flight. Pure horizontal-thrust generation by means of fixed ducted fans is conceivable in addition.

Alongside preferably fully autonomous operation of the aircraft—it is possible for human pilots, if sufficiently qualified, to be allowed to control the aircraft manually, which gives the apparatus according to the invention the greatest possible degree of flexibility in terms of handling.

Details of the wings may be disclosed in U.S. Pat. No. 2,712,421, and further details of the propellers and rotors may be disclosed in U.S. patent Ser. No. 10/131,426, each of which is incorporated by reference herein in its entirety.

### BRIEF DESCRIPTION OF THE DRAWING

An exemplary embodiment of the invention will be described in more detail hereinbelow and is illustrated in the drawing.

FIG. 1 shows the plan view of an aircraft.

FIG. 2 depicts an isometric view of an aircraft, wherein the wings are shown in an extended configuration and the rear propellers are shown in an angled orientation.

FIG. 3 depicts a front elevation view of the aircraft of FIG. 2, wherein the wings are shown extended configuration and the rear propellers are shown in a cruising orientation.

FIG. 4 depicts another front elevation view of the aircraft, wherein the wings are shown in a folded configuration and the rear propellers are shown in a take-off/landing orientation.

FIG. 5 depicts a top plan view of a portion of an aircraft, showing an internal duct extending between a nose of the aircraft and a horizontal fan mounted to the wing.

FIG. 6 depicts moveable louvers applied on top of the horizontal fan of FIG. 5, wherein the louvers are shown in a closed position.

FIG. 7 depicts the movable louvers of FIG. 6, wherein the louvers are shown in an open position.

### DETAILED DESCRIPTION OF THE INVENTION

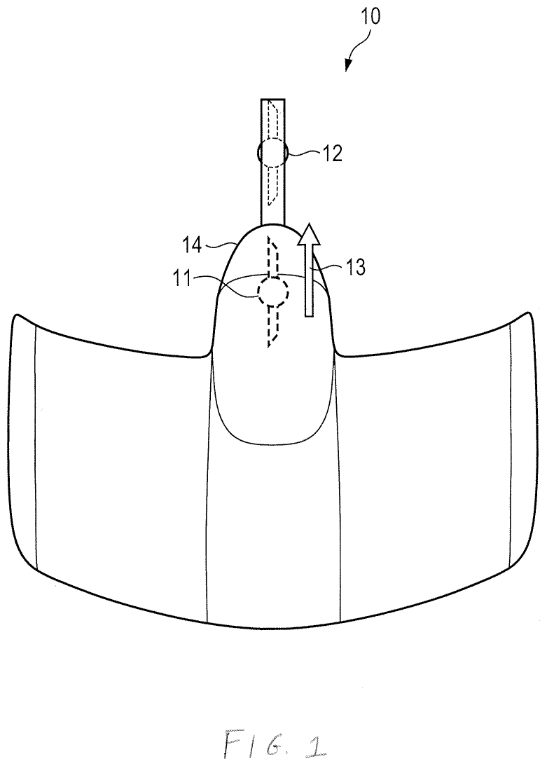

FIG. 1 illustrates the design features of a preferred configuration of the aircraft 10 according to the invention.

The terms ‘fan,’ ‘rotor’ and ‘propeller’ may be used interchangeably herein.

As is evident on its nose 14, the aircraft 10 has an emergency rotor, 11, 12, which can be deployed upward, as seen in relation to the figure, and therefore counter to the cruising direction. Whereas this narrow emergency rotor 11, 12, in its rest position 11, is integrated in an essentially concealed state in an extremely small amount of installation space in the fuselage of the aircraft 10, it can be moved if required, by a translatory movement approximately one and a half times its diameter, into a use position 12, in which it projects forwards, in front of the cockpit, out of the body of the aircraft. In this end position, it is possible for the emergency rotor 11, 12 to assist, or replace, any lifting rotors in the event of an emergency landing or to counteract stalling when cruising has been slowed down as a result of malfunction.

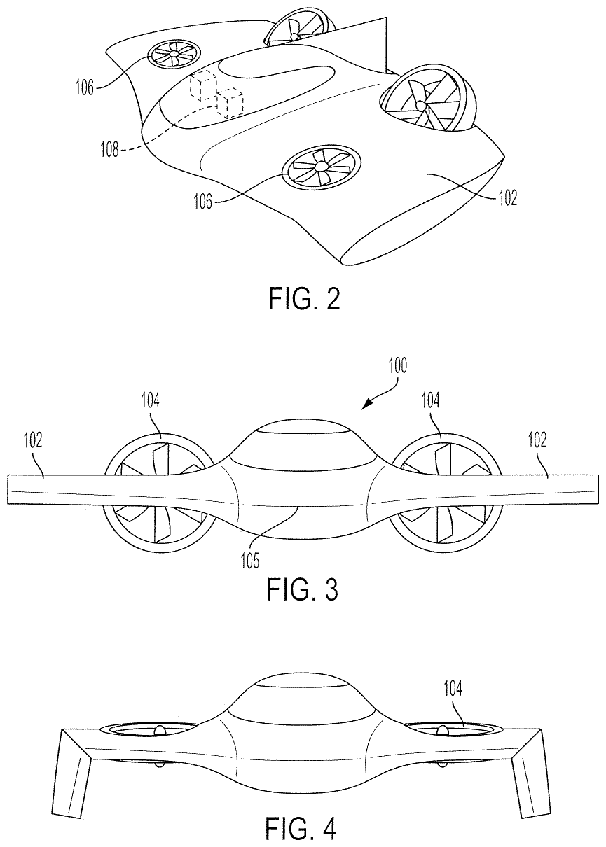

FIGS. 2-4 depict an aircraft 100. The aircraft 100 shown in those figures may appear different from the previously described aircraft, however, most (if not all) of the details of the previously described aircraft also apply to aircraft 100.

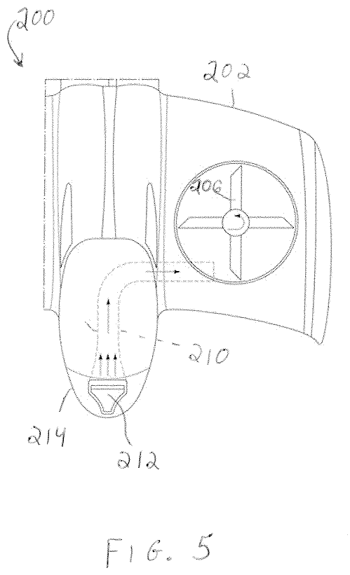

The aircraft 100 includes foldable wings 102. The wings 102 are shown in a folded configuration in FIG. 4 and an extended configuration in FIG. 3. A motor or solenoid is configured to move the wings between those configurations.

Rear propellers 104 are mounted on the trailing edge of the airfoils or wings 102 (i.e., the edge furthest from the nose 105). Propellers 104 may be referred to as cruising propellers because they are used during the cruising operation of the aircraft (at least in one position of the propellers 104). The propellers 104 are configured to pivot between two different positions, as shown in FIGS. 2-4. In the vertical position of the propellers 104 shown in FIG. 3, the propellers 104 generate maximum horizontal thrust for cruising operation of the aircraft (i.e., while the aircraft is flying through the air). In the horizontal position of the propellers 104 shown in FIG. 4, the propellers 104 generate maximum vertical thrust for take-off and landing operations of the aircraft. A motor or solenoid is configured to move the propellers 104 between those two positions. Alternatively, the propellers 104 may be immovable and fixed in a vertical position, as shown in FIG. 2.

Horizontally mounted propellers 106 are fixedly mounted and integrated into the wings 102. Unlike the propellers 104, the position of the propellers 106 is fixed, however, those skilled in the art will recognize that the propellers 106 could be modified so that they are pivotable between vertical and horizontal positions. The propellers 106 generate maximum vertical thrust for take-off and landing operations of the aircraft. The propellers 106 may also be referred to herein as lifting propellers.

The propellers 104 and 106, which may also be referred to herein as fans, may be operated by a fully-electric drive. To that end, a battery charging system 108 including a charger, an inverter and a fast-charging battery are positioned within the fuselage of the aircraft for powering the propellers 104 and 106. The fuselage may also be configured to carry one or more passengers.

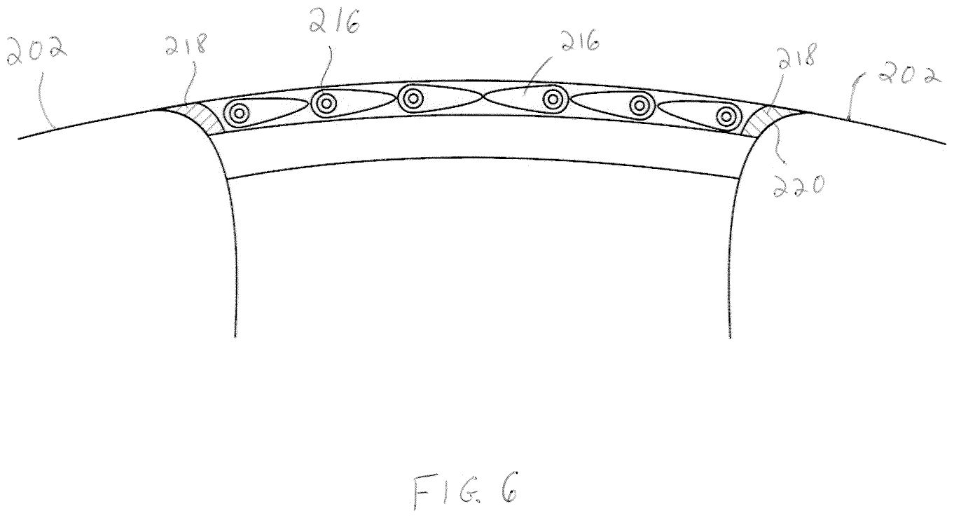

FIGS. 5-7 depict views of an aircraft 200. The aircraft 200 shown in those figures may appear different from the previously described aircraft 100, however, most (if not all) of the details of the previously described aircraft 100 also apply to aircraft 200. Only a segment of the aircraft 200 is shown in FIG. 5. An air duct 210 extends between an opening 212 formed on the nose 214 of the aircraft 200 and the horizontally mounted propeller 206 that is fixedly mounted to the wing 202. In operation, air is delivered to the propeller 206 via the duct 210, as depicts by the arrows. Although not shown, air ducts that are similar to duct 210, may extend to the propeller 206 on the opposite wing 202, as well as any rear propellers 104 (not shown in these views). Accordingly, the propellers may be referred to as either “ducted propellers” or “ducted fans.”

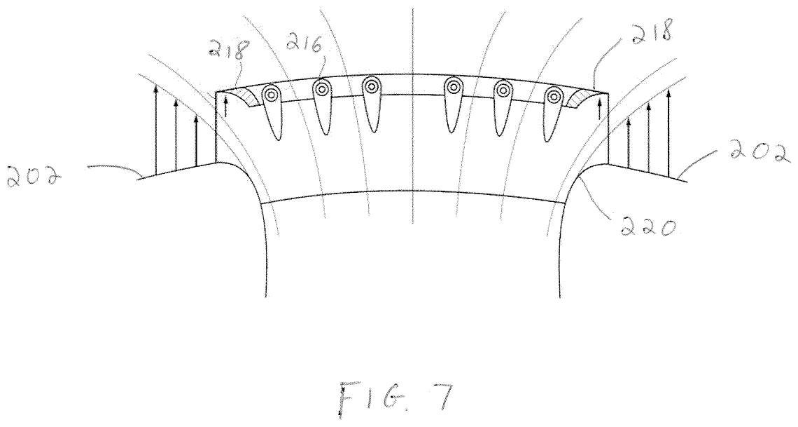

FIGS. 6 and 7 depict louvers 216 that are configured to selectively cover the horizontally mounted propellers 206. It is noted that the louvers 216 are omitted from FIG. 5 for clarity purposes. Each louver 216 is rotatable about a shaft (or otherwise moveable) between a closed position (FIG. 6) and an open position (FIG. 7). The louvers 216, which are flush with the top face of the wing 202, may be moved to the closed position during the cruising operation of the aircraft 200 for aerodynamic purposes. The louvers 216 may be moved to an open position at any time during operation of the propellers 206 to permit the exit or entrance of air therethrough. A motor or solenoid is configured to move the louvers 216 between those positions. It is noted that the louvers are shown in a closed position in FIG. 2.

A sealing ring 218 surrounds the louvers 216 and is moveable between a retracted position (FIG. 6) and a deployed position (FIG. 7). The louvers 216 are mounted to the sealing ring 218 and move therewith between the retracted and deployed positions. The lower surface of the sealing ring 218 is configured to be in sealing relationship with an opening 220 formed in the wing 202. It should be understood that the opening 220 accommodates the body of the propeller 206. The sealing ring 218 may be moved to the retracted position, which is flush with the top face of the wing 202, during cruising operation of the aircraft 200 for aerodynamic purposes. Alternatively, the sealing ring 218 may be moved to the deployed (i.e., extended) position at any time during operation of the propellers 206 to permit the exit or entrance of air, as depicted by the arrows in FIG. 7. A motor or solenoid is configured to move the sealing ring 218 between those positions.

What is claimed is:

1. An aircraft comprising an emergency rotor that is configured to be deployed from a rest position into a use position.

2. The aircraft as claimed in claim 1, wherein the emergency rotor is configured to be deployed in a direction which is counter to a cruising direction of the aircraft.

3. The aircraft as claimed in claim 1, wherein the emergency rotor is arranged on a nose of the aircraft.

4. The aircraft as claimed in claim 1, wherein the aircraft has a fully electric drive.

5. The aircraft as claimed in claim 1, wherein the aircraft comprises wings which either are, or are configured to be, angled.

6. The aircraft as claimed in claim 1, wherein the aircraft comprises a battery charging system.

7. The aircraft as claimed in claim 1, wherein the aircraft comprises horizontally fixed ducted fans for take-off and landing.

8. The aircraft as claimed in claim 7, wherein the aircraft has louvers and the horizontal ducted fans are configured to be selectively covered by the louvers.

9. The aircraft as claimed in claim 1, wherein the aircraft comprises vertically fixed ducted fans for generating propulsion.

10. The aircraft as claimed in claim 1, wherein the aircraft is configured to be controlled fully autonomously.
